(19) United States
(12) Patent Application Publication
(10) Pub. No.: US 2024/0288266 A1
(43) Pub. Date: Aug. 29, 2024

(54) Optical Metrology System and Methods for the Measurement of Optical Surfaces

(71) Applicant: MBRYONICS Ltd, Galway (IE)

(72) Inventors: Niamh Fitzgerald, Galway (IE); Ruth Mackey, Galway (IE); Liz Daly, Galway (IE); David Mackey, Galway (IE); Louis Martin, Galway (IE); Alexander V Goncharov, Co. Galway (IE)

(21) Appl. No.: 18/590,399

(22) Filed: Feb. 28, 2024

(30) Foreign Application Priority Data
Feb. 28, 2023 (GB) 2302951.5

(51) Int. Cl. G01B 11/24; G01B 11/30

(52) U.S. Cl. CPC G01B 11/2441; G01B 11/30

(57) ABSTRACT

An optical metrology system for measurements of large aperture and freeform optical surfaces the system (100) comprising: a first mirror, having a plurality of degrees of freedom of motion; one or more optical elements comprising reconfigurable optical elements; and a controller (200). The system (100) is configured: configured to be optically coupled to an externally located surface under test, SUT (125), and to capture measurement data from each of a plurality individual subapertures, SAs, across the area of the SUT, each SA having a surface area smaller than that of the SUT. The metrology system is further configured to provide partial nulling of each of the SA measurements across the SUT, based on controlled adjustment of one or more of the metrology system, and the elements thereof. The measurement data, comprising measurements relating to the plurality of individual subapertures, SAs, is stitched to describe the full surface of the SUT. Methods and a software system for use in the measurement of large aperture and freeform optical surfaces are also described.

### CROSS-REFERENCE TO RELATED APPLICATIONS

This application claims priority to United Kingdom Application No. 2302951.5 filed Feb. 28, 2023, which is incorporated by reference herein as if reproduced in its entirety.

### FIELD

The present specification relates to a partially nulling optical metrology system, methods and software system for the measurement of freeform optical surfaces.

### BACKGROUND

Optical surface metrology is the bottleneck of the freeform optical surface manufacturing process chain. The manufacturing workflow steps iterate between machining the surface and measuring the surface error to converge towards the target surface shape. In some current arrangements optical surface manufacturing processes require the optic to be removed from the vacuum chuck for measurement of the surface error. That is, the optical surface is measured off-machine in a separate metrology unit and is then re-mounted and re-aligned on the vacuum chuck for further machining pending the outcome of the surface measurement. This process is time consuming and a source of alignment errors, which limits the possibility of mass manufacturing of freeform optical surfaces.

Therefore, there is a need to provide a system that overcomes the drawbacks of existing solutions.

### SUMMARY

The specification provides exemplary arrangements directed to addressing the problems noted above associated with the previous arrangements. The specification and claims are directed to providing an improved and alternative approach for the measurement of optical surfaces including freeform optical surfaces.

The scope of the invention is in accordance with the appended claims.

An optical metrology system according to arrangements of the specification is provided. According to embodiments of the invention individually partially nulled subapertures, SA, are stitched to retrieve the total surface error of the surface under test, SUT.

The exemplary arrangements of the specification advantageously provide partial nulling through a novel and inventive configuration of the SUT and the metrology system. Advantageously there is provided a flexible configuration, which comprises mounting the SUT and using a positioning mechanism to position the SA for measurement. In one embodiment the SUT is positioned on a rotational spindle and the positioning mechanism comprises a relay and tip/tilt mirror in the metrology machine to precisely position the SA for measurement. In the exemplary methods presented here, the manufacturing and measuring processes are decoupled. This advantageously removes any inherent metrology bias that may exist in other prior measuring systems, such as confocal ones. The exemplary methods of embodiments of the specification provides partial nulling which require six degrees of freedom. In embodiments of the specification, a digital twin of the entire system is created using optical design software prior to commencing measurements. The digital twin is configured for use to solve for the most efficient machine path for the required SA overlap. Further the partial nulling requirements for the hardware are pre-calculated, modelled, and tested for every SA prior to recording of any SA data.

Advantageously, there is provided an optical metrology system for measuring the wavefront error (namely departure of the manufactured optic shape from its design shape) of large, non-standard optical surfaces. According to embodiments of the specification the measured surface information from individual SAs, each smaller than the full SUT size, are stitched together to reconstruct the full surface. Non-standard optics may have regions that are very steep, resulting in highly-packed interference fringes when examined with a conventional interferometer. These dense fringes may completely bury the more subtle fine structure of the optic, saturating the measuring range of the instrument in the process. According to embodiments of the specification there is provided a method to partially null these fringes, wherein the partial nulling comprises reducing their number and increasing their spacing, making measurement of the underlying surface profile possible. Partial nulling is achieved through configuration of the SUT and the metrology machine itself. In one embodiment, the SUT is mounted on a rotational spindle, which is mechanically separate from the metrology system. The metrology system which includes a reconfigurable relay mirror and a reconfigurable tip/tilt mirror, each having six degrees of freedom motion. These reconfigurable mirrors (relay and tip/tilt) are positioned such that the fringes from the particular SA under consideration are partially nulled.

Thus, the manufacturing and measuring processes according to embodiments of the specification, are completely decoupled, removing the metrology bias that exists in other systems, such as confocal ones. In addition, in the arrangements of the specification variable optical elements to further null the fringes at each SA position, maximising the available measurement range for that particular measurement.

In exemplary embodiments, a digital twin of the full system is used to plan the SA lattice layout using a custom software routine, model the nulling required and achievable at each location, and simulate the machine output at that location. Lattice design can be iterated upon to achieve the accuracy required if necessary. The arrangements of the specification provide that all of this planning can be done prior to taking any actual data measurements. The methods further provides that when the measurements have been taken, stitching of SAs is performed, to recreate the SUT over its full diameter. The stitching is performed using software. The software is optimised for speed, through code design and use of parallel processing, when stitching SA obtained with high-resolution cameras. The arrangement advantageously is configured to provide that the computation time required to recreate a large diameter SUT from many SA measurements does not become impractical. The system is advantageously configured to be compact to allow for integration into a single point diamond turning, SPDT, polishing machine. Thus, arrangements of the specification support an integrated or inline system making inline measurements possible.

The methodology described advantageously partially nulls many individual sub-aperture measurements across the surface under test (SUT). The position of the SUT on a rotational spindle, and the placement of a relay and a tip/tilt mirror, each with six degrees of freedom motion, works to achieve partial nulling for each SA. Lattice design is employed to optimise the machine measurement path for a given amount of SA overlap. A digital twin of the entire system is used to simulate and test the partial nulling capabilities for each SA in a given lattice design. The SUT shape can then be reconstructed with stitching algorithms to combine the individual measurements. The novel measurement planning and process allows for large aperture optics with challenging surface topographies to be measured.

According to further exemplary arrangements a partial nulling methodology is presented for the measurement of freeform optical surfaces.

According to a first aspect there is provided an optical metrology system (100) for measurement of large aperture optical surfaces the system (100) comprising:
a first mirror (115), comprising a beam steering mirror (115) having a plurality of degrees of freedom of motion;
a controller (200) for controlling the position of the mirror;
wherein the system (100) is configured:
   to be optically coupled to a surface under test, SUT;
   to capture measurement data of the optical surface of a surface under test, SUT, wherein measurement data is captured from each of a plurality individual subapertures, SAs, across the area of the SUT, each SA having a surface area smaller than that of the SUT;
wherein the mirror (115) is adjustable relative to the SUT and configured to be positioned such that an at least partial nulling of each of the SA measurements across the SUT is provided;
wherein the measurement data, comprising measurements relating to the plurality of individual subapertures, SAs, is stitched to describe the full surface of the SUT.

The system 100 may be configured to provide for re-construction of large-aperture optical surfaces such as a freeform optical surface or an asphere. The system is configured to support measurements of optical properties of the optical surface, including one or more of: phase map data, wavefront measurements, and wavefront error measurements. The mirror 115 may be a tip/tilt mirror mounted such that it is movable about one or more of the X, Y and Z axes thereof. The mirror 115 may be a reconfigurable mirror. The system further includes an exit pupil 105, optical elements 110, and a beam to interferometer pupil 130. The SA measurements may comprise fringes or phase data, and the fringes or phase data for each SA is partially nulled. The optical elements 110 may comprise partial nulling, or focusing, elements 110. The mirror 115 may comprise a tip/tilt mirror configured to be mechanically shifting and tilting for the measurement of SUT surfaces, including surface having a base concave surface form. For measurement of concave surfaces, the mirror 115 is preferably positioned at the centre of curvature of the SUT. A partial nulling is provided controlling the position of the mirrors such that the chief ray is normal to the SUT for each sub-aperture.

In an embodiment, the mirror may comprise a single static custom phase plate to achieve partial nulling, such an arrangement is advantageous in the mass production of a single freeform optical surface.

In an embodiment, the system may further comprise, or the mirror may comprise a reconfigurable spatial light modulator, SLM, arranged in double pass, wherein the reconfigurable SLM used in double pass is oriented in a plane conjugate to the SUT and configured to provide partial nulling of individual sub apertures.

In an embodiment of the first aspect, the system further comprises a second mirror (120), the second mirror comprising a relay mirror (120) having a plurality of degrees of freedom of motion.

In an embodiment of the first aspect, the first and second mirrors are reconfigurable mirrors. The first mirror 115 and the second relay mirror 120 may be configured to be mechanically shifting and tilting for the measurement of SUT surfaces. In a preferred arrangement, the tip-tilt mirror 115 and the relay mirror 120 are adjustable for positioning in co-operation for measurement of SUT surfaces, including convex surfaces. An at least partial nulling is provided by adjusting including for example controlling the position of the mirrors such that the chief ray is normal to the SUT for each sub-aperture.

In an embodiment of the first aspect, each mirror (115, 120) is adjustable relative to the SUT, and the plurality of SAs, across the SUT, wherein the position of each mirror (120, 115) is controllable to provide an at least partial nulling of the individual sub-aperture measurements across the surface under test, SUT.

In an embodiment of the first aspect, each mirror has six degrees of freedom of motion. The mirrors may be mounted such as to be movable about the X, Y and Z axes thereof with six degrees of freedom of motion. The position is controllable by the controller.

In an embodiment of the first aspect, the first and second mirrors are adjustable to allow positioning of the metrology system such that measurements are made at normal incidence to the SUT, and the plurality of SAs, across the SUT.

Such positioning supports an at least partial nulling of the measurement data for each SA.

In an embodiment of the first aspect the system is configured to measure wavefront errors of the optical surface of the SUT, by measuring wavefront errors from each of a plurality of individual subapertures, SAs, of the SUT, each SA having a surface area smaller than that of the SUT.

In an embodiment of the first aspect, the system (100) is configured for optically coupling to a surface under test (125), SUT and wherein the controller (200) is configured to control the position of one or more of the: metrology system 100, the first mirror (115), and the second mirror (120), to position an optical beam on the SUT.

In an embodiment of the first aspect wherein the SUT (125) is mountable to a rotational spindle (126) and wherein the controller (200) is configured to control the position of the SUT, to allow selection of a one or more individual SAs, such that the optical beam is positioned on an SA of the SUT.

The position of the SUT on a rotational spindle, and provision of a relay and a tip/tilt mirror, each with six degrees of freedom motion, works to achieve partial nulling for each SA.

In an embodiment of the first aspect the SUT is mountable to a support comprising a rotational spindle, wherein the SUT is mountable independently of the metrology system (100), such that the SUT is mounted mechanically independently of the metrology system.

The arrangement of the system advantageously allows for optical coupling of the optical metrology system to an externally located SUT. The SUT may for example be mounted to a chuck or spindle of a manufacturing or machining system. Control of and adjustments of the optical metrology system, including control and position of the first and second mirrors is performed separately and independently of the SUT. The optical metrology system may be located in-line with, or integrated with, a manufacturing system or manufacturing process.

In an embodiment of the first aspect the measurement data comprises one or more phase maps or interference fringe data.

In an embodiment of the first aspect the system further comprises an interferometer, wherein the measurement data from each of the subapertures, SAs, comprises interference fringe data.

In an embodiment of the first aspect each of the first and second mirrors (115, 120) is an adjustable mirror configured to be positioned such that the fringes or phase maps from an SA, currently under test, of the plurality of SAs of the SUT are at least partially nulled.

Non-standard optics also referred to herein as freeform optics, of the SUT, may have regions that are steep, resulting in highly-packed interference fringes when examined with an interferometer. These dense fringes may effectively obscure the more subtle fine structure of the optic, therein saturating the measuring range of the instrument in the process. Embodiments of the specification allows for control of the position of the first and/or second mirror, as required, relative to the SUT to partially null the measurement data for each SA.

In an embodiment of the first aspect the system is further configured to provide a reconstruction of a freeform optical surface SUT from a plurality of partially-nulled subaperture, SA, phase maps, and further wherein the SAs are overlapping SAs.

In an embodiment of the first aspect subaperture measurements of the SUT are performed in an inline process, wherein the metrology measurements are captured between steps machining the SUT during the process of manufacture of the SUT.

The arrangements of the specification provide a metrology system that is advantageously configured for operation in an inline method integrated with the methods and processes for manufacture of an SUT. In effect by virtue of the arrangements of the specification measurements of the SUT may be made in real-time/in parallel with the manufacturing processes. The arrangement accordingly supports an improved manufacture process that benefits from the real-time feedback on surface properties.

Advantageously, in comparison with prior approaches, the arrangements of the specification obviate the need to take the SUT out of SUT support/mount in order to perform measurements. This allows for decoupling of the metrology bias that may exist in other inline metrology systems, such as confocal ones. In an embodiment of the first aspect the system further comprises a lattice design module (310) configured to optimise the layout of the subapertures, SAs, of the SUT.

The lattice design module is configured to receive input and to provide as an output an optimised layout of subapertures. This output may be provided to the controller to control operation of the metrology system and to adjust optical components or the position of the SUT as requirement for a measurement run.

The arrangement of the lattice design module and the system 100 and SUT mount allows for full measurement coverage/optical metrology over a target area of an SUT while reducing or minimising the required measurement times. Metrology may be directed to the full area of the SUT (a plurality of SAs thereof) or a predefined area thereof. The lattice design module (310) may be configured for a reduction in the number of individual subapertures required to cover the SU, and to output a subaperture overlay pattern. The number of subapertures selected and the subaperture overlay pattern are provided to improve efficiency of the measurement processes.

The lattice design module advantageously provides instructions for control of the optical metrology/measurements of the SUT. The lattice design module provides as output a lattice design for a particular SUT.

In an embodiment of the first aspect the lattice design module (310) is configured to create an optimised lattice configuration (311) wherein the lattice configuration (311) (or lattice design) comprises one or more of a definition of a measurement trajectory for a SUT, and a stitching algorithm for stitching of SAs of an SUT.

In an embodiment of the first aspect the lattice design module (310) is configured to use one or more the following inputs:
(i) a high-resolution target surface or point cloud of the target surface, and further wherein the target surface may be obtained from an optical design software;
(ii) metrology unit constraints, comprising data that is fixed and known for any particular machine;
(iii) metadata relating to the desired outputs including desired resolution, surface dimension properties, and maximum subaperture dimensions.

In an embodiment of the first aspect a predefined minimum threshold requirement for creation of a lattice design (311) is defined based on a required fringe resolution criteria for every subaperture, SA.

The required fringe resolution criteria for one or more subapertures may comprise a predefined resolution.

In an embodiment of the first aspect in the event that the required fringe resolution criteria threshold is not met, the lattice configuration requirements are updated, and wherein the lattice configuration requirements may comprise one or more of (i) inter-annulus and (ii) adjacent overlap percentages.

The lattice design module 310 then iteratively repeats the previous steps until a suitable solution is achieved.

In an embodiment of the first aspect the lattice configuration is provided in a format for inputting to commercial ray-tracing software via an Application Programming Interface (API) to create a digital twin of the physical measurement system.

Using this digital twin, all interferograms are simulated for the output of each subaperture. Fringe resolution analysis via image processing is used to determine if the configuration is sufficient for nulling.

In an embodiment of the first aspect the system is configured to be integrated into an industrial machining or polishing environment.

The ability to perform measurements inline drives the compact and reconfigurable design of the invention so that it can be integrated into an industrial machining or polishing environment. Advantageously the arrangement of the claims and specification supports the performance measurements/optical metrology inline without touching the SUT as it sits in the SUT mount/chuck such that the method is completely contactless.

In an embodiment of the first aspect any mechanical bias of the system is removed from the data collection process by using a tip/tilt mirror and relay mirror in co-operation to shift the subaperture measurement position on the SUT, which is mounted on a rotational spindle.

In an embodiment of the first aspect the system further comprises one or more static and variable optical elements and one or more mechanical stages having one or more degrees of freedom motion, wherein the one or more static and variable optical elements and the one or more mechanical stages are configured so as to provide partial nulling of individual sub apertures.

In an embodiment of the first aspect further comprises at least two cylindrical lenses, wherein the at least two cylindrical lenses are configured such that they are operable, in conjunction with one another, so as to provide partial nulling of individual sub apertures.

In an embodiment of the first aspect the system further comprises a static phase plate, wherein the static phase plate is configured to rotate about an optical axis so as to enable partial nulling of individual sub apertures.

In an embodiment of the first aspect the freedom of movement of the optical elements or groups of optical elements, suitably mounted in precision stages, to move with six degrees of freedom allows each subaperture to be measured at normal incidence.

According to a second aspect methods of performing measurements of an optical surface using the system as claimed in any preceding claim. The methods include controlled and precision adjustments of one or more of the system 100, first mirror, second mirror, optical elements of the system 100 relative to an SUT.

In one embodiment the method of measuring an optical surface comprises:
capturing measurement data of the optical surface of a surface under test, SUT, wherein measurement data is captured from each of a plurality individual subapertures, SAs, across the area of the SUT, each SA having a surface area smaller than that of the SUT;
stitching of the measurement data comprising measurements relating to the plurality of individual subapertures, SAs, to describe the full surface of the SUT;
adjusting the first mirror such that is it positioned to provide an at least partial nulling of each of the SA measurements across the SUT.

The methods further provide for precision adjustment of the SUT relative to the metrology system.

According to a third aspect, there is provided a system for creation of a digital twin of the metrology system and arrangement. The digital twin may be used including to provide improved measurement and control.

According to a fourth aspect there is provided an optical metrology system (100) for reconstruction of a large aperture freeform optical surface, the system (100) comprising:
a first reconfigurable mirror (115), comprising a tip/tilt mirror (115) having six degrees of freedom of motion; a controller (200 ) for controlling the position of the mirror;
an interferometer; wherein the system (100) is configured: to be optically coupled to a surface under test, SUT; to capture measurement data of the optical surface of a surface under test, SUT, wherein measurement data is captured from each of a plurality individual subapertures, SAs, across the area of the SUT, each SA having a surface area smaller than that of the SUT;
wherein the mirror (115) is adjustable relative to the SUT and configured to be positioned such that an at least partial nulling of each of the SA measurements across the SUT is provided, wherein the fringes from the SA under consideration are at least partially nulled;
wherein the measurement data, comprising the plurality of subaperture phase maps relating to each the plurality of individual subapertures, SAs, is stitched to describe the full surface of the SUT.

In one embodiment of the fourth aspect the system further comprising a second reconfigurable relay mirror having six degrees of freedom motion and configured to be positioned in co-operation with the first mirror such that an at least partial nulling of each of the SA measurements across the SUT is provided.

According to a fifth aspect there is provided a partially nulling optical metrology system (100) for the measurement of large aperture and freeform optical surfaces, the metrology system comprising: a first mirror (115) having a plurality of degrees of freedom of motion; one or more optical elements comprising reconfigurable optical elements; a controller;
the metrology system (100) configured to be optically coupled to an externally located surface under test, SUT (125), and to capture measurement data from each of a plurality individual subapertures, SAs, across the area of the SUT, each SA having a surface area smaller than that of the SUT; and
the metrology system configured to provide partial nulling of each of the SA measurements across the SUT, based on controlled adjustment of one or more of the metrology system and the elements thereof;
   wherein a position of the metrology system relative to the SUT is adjustable, the metrology system being coupled to a moveable mount and the controller operable to adjust the position of the metrology system;
   wherein the reconfigurable optical elements are adjustable relative to the SUT;
   wherein the first mirror is adjustable relative to the SUT; and
   wherein the measurement data, comprising measurements relating to the plurality
of individual subapertures, SAs, is stitched to describe the full surface of the SUT.

The first mirror may comprise a beam steering mirror (115), wherein the beam steering mirror is reconfigurable, having six degrees of freedom of motion.

In one embodiment the system may further comprise a second mirror (120), the second mirror comprising a relay mirror (120) wherein the relay mirror is reconfigurable, having six degrees of freedom of motion.

In one embodiment the first and second mirrors (115, 120) may be adjustable relative to the SUT, and the plurality of SAs, across the SUT, wherein the position of the first and second mirrors (120, 115) is controllable to provide a partial nulling of the individual sub-aperture measurements across the surface under test, SUT.

In one embodiment the position of the metrology system may be adjustable to allow positioning of the metrology system such that measurements are made substantially normal to the SUT, and the plurality of SAs, across the SUT.

In one embodiment the system may be configured to measure wavefront errors of the optical surface of the SUT, by measuring wavefront errors from each of a plurality of individual overlapping subapertures, SAs, of the SUT, each SA having a surface area smaller than that of the SUT, and wherein a reconstruction of the optical surface, is provided by the plurality of partially nulled overlapping subaperture measurements.

In one embodiment, the controller (200 ) may be configured to control the position of one or more of the: metrology system (100), the first mirror (115), and the second mirror (120), to position an optical beam on the SUT, as required.

In one embodiment, the SUT may be configured according to one or more of the following:
(i) wherein a position of the SUT is adjustable, the SUT being coupled to a moveable mount, and configured for movement independently of the metrology system such that any mechanical bias of the system is removed from the data collection process; and
(ii) wherein the controller (200) is configured to control the position of the SUT, to allow selection of one or more individual SAs, such that the optical beam is positioned on an SA of the SUT;
(iii) wherein the SUT (125) is mountable to a rotational spindle (126) and wherein the controller (200) is configured to control the position of the SUT, to allow selection of one or more individual SAs, such that the optical beam is positioned on an SA of the SUT.

The system may further comprise an interferometer, wherein the measurement data from each of the subapertures, SAs, comprises phase maps or interference fringe data.

In embodiments according to the specification, the system may further be configured to be integrated into an industrial machining or polishing environment; and the metrology system may be configured to capture measurement data according to one or more of the following:
(i) wherein measurement data comprising subaperture measurements of the SUT is captured in an inline process; and
(ii) wherein measurement data comprising subaperture measurements of the SUT is captured between machining steps during the process of manufacture of the SUT.

In one embodiment, the system may further comprise a lattice design module (310) arranged according to one or more of the following:
(i) wherein the lattice design module is configured to create an optimised lattice configuration (311) wherein the lattice configuration (311) comprises one or more of a definition of a measurement trajectory for a SUT, and a stitching algorithm for stitching of SAs of an SUT;
(ii) wherein the lattice design module (310) is configured to use one or more the following inputs:
(a) a high-resolution target surface or point cloud of the target surface, and further wherein the target surface may be obtained from an optical design software;
(b) metrology unit constraints, comprising data that is fixed and known for any particular machine;
(c) metadata relating to the desired outputs including desired resolution, surface dimension properties, and maximum subaperture dimensions.

In one embodiment, a predefined minimum threshold requirement for creation of a lattice design (311) may be defined based on a required fringe resolution criteria for every subaperture, SA and wherein in the event that the required fringe resolution criteria threshold is not met, the lattice configuration requirements are updated, and wherein the lattice configuration requirements may comprise one or more of (i) inter-annulus and (ii) adjacent overlap percentages.

In one embodiment the optical elements are configured to provide partial nulling of individual sub apertures, the optical elements comprising one or more of the following:
(i) at least two cylindrical lenses, wherein the at least two cylindrical lenses are configured to be adjustable and for use in conjunction with one another, and configurable to provide partial nulling of individual subapertures;
(ii) a static phase plate, wherein the static phase plate is configured to rotate about an optical axis to provide partial nulling of individual subapertures.

According to a sixth aspect there is provided a method for the capturing measurement data of the optical surface of a surface under test, SUT, in a partially nulling metrology system as claimed in any preceding claim, the method comprising:
optically coupling the metrology system to a SUT, wherein the SUT is located externally of the metrology system;
capturing measurement data from each of a plurality individual subapertures, SAs, across the area of the SUT, each SA having a surface area smaller than that of the SUT;
stitching of the measurement data comprising measurements relating to the plurality of individual subapertures, SAs, to describe the full surface of the SUT;
controlling the metrology system and the elements thereof to provide partial nulling of each of the SA measurements across the SUT, wherein said partial nulling is provided based on one or more of the following:
   adjusting the metrology system relative to SUT, wherein the metrology system is mounted to a movable mount for positioning relative to the SUT;
   adjustment of one or more optical elements of the metrology system relative to the SUT;
   adjustment of the one or more mirrors of the metrology system relative to the SUT;
the method further comprising:
   adjusting a position of the SUT relative to metrology system as required, the SUT being mountable to a movable mount.

In one embodiment, the method further comprises:
controlling the optical metrology system and the measurement trajectory for the SUT based on operating a lattice design module to create an optimised lattice configuration and to define the measurement trajectory and stitching algorithm for stitching of the SAs in an iterative process.

### BRIEF DESCRIPTION OF THE DRAWINGS

The arrangements of the present application will now be described with reference to the accompanying drawings in which:

FIGS. 1A and 1B illustrate a system having a central position for alignment and central sub-aperture measurement according to arrangements of the present specification;

FIG. 2 illustrates an optic having two superimposed sub-aperture footprints on the surface according to arrangements of the present specification;

FIGS. 3A and 3B illustrate degrees of freedom of system components for measurement of a freeform optical surface with a convex base shape of a system according to arrangements of the present specification;

FIGS. 4A and 4B Illustrate degrees of freedom of system components for the measurement of a freeform optical surface with a base shape that departs from convex in a system according to arrangement of the present specification;

FIG. 5 illustrates a system layout and process steps therein according to arrangements of the present specification;

FIG. 6 illustrates a method for lattice design according to arrangements of the present specification.

### DETAILED DESCRIPTION OF THE INVENTION

The present invention will be illustrated using the exemplified embodiments shown in the figures. While this invention has been shown and described with reference to certain illustrated embodiments thereof, it will be understood by those skilled in the art that various changes in form and details may be made therein without departing from the scope of the invention encompassed by the appended embodiments. The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

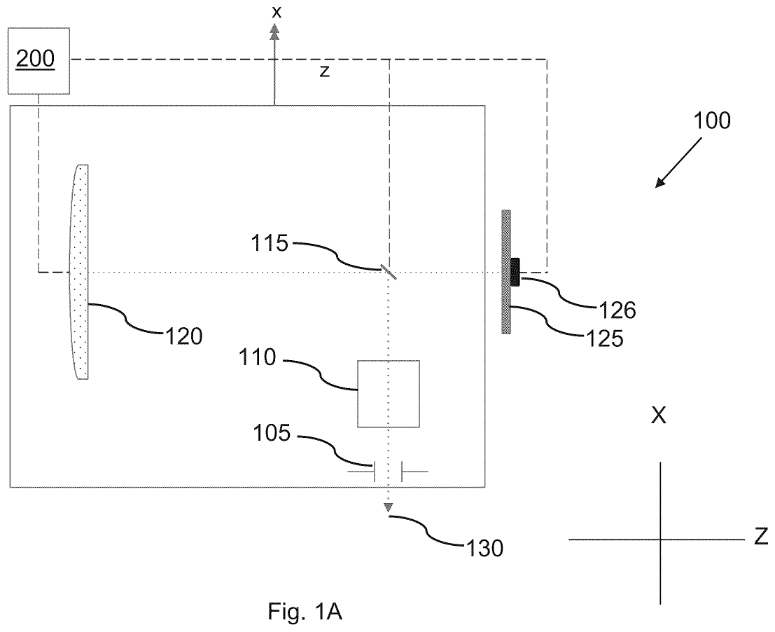

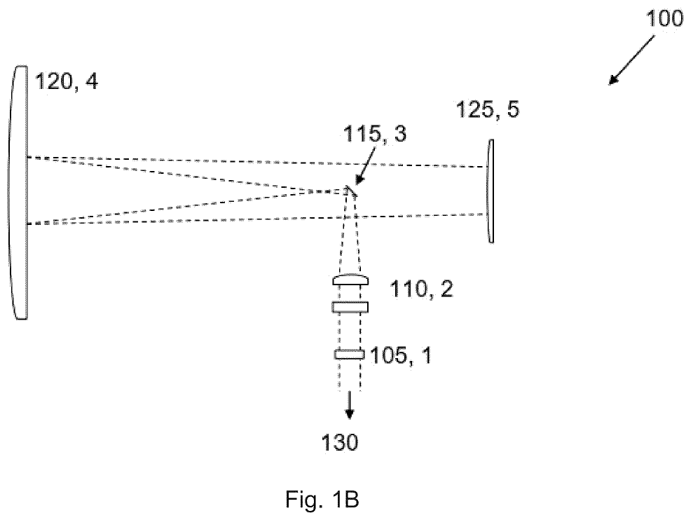

The exemplary arrangements are configured to carry out partial nulling of a freeform SUT, where the measured root mean square (rms) wavefront error can be reconstructed from overlapping sub-aperture measurements across the SUT. Partial nulling is implemented about the exit pupil, labelled as 105, 1 in FIGS. 1A and 1B. The exit pupil is conjugated to the SUT, denoted by 125,5 in FIGS. 1A and 1B, for all configurations. The exit pupil is also relayed to the interferometer pupil plane for measurement, denoted by 130, 6 in FIGS. 1A and 1B.

The sub-aperture diameter defines the amplitude of the wavefront aberration. That is, the influence of ρ in the aberration function W (H, ρ) gives the geometrical wavefront deformation in the exit pupil as a function of the normalised field and aperture vectors denoted by H and ρ respectively:

$$W ( \vec{H} , \vec{ρ} ) = {\sum }_{j , p , m , n} {( {W}_{k , l , m} )}_{j} {( \vec{H} \cdot \vec{H} )}^{p} {( \vec{H} \cdot \vec{ρ} )}^{m} {( \vec{ρ} \cdot \vec{ρ} )}^{{n \vec{𝒥} )}^{n}}$$

over all surfaces j, where the sub-indices p,m,n represent integers k=2p+m, l=2n+m and the coefficients are denoted by W_{k,l,m} and the indices k, l, m in each coefficient describe the algebraic power of the field, pupil and azimuthal angle between the vectors.

Thus, combining multiple subapertures over the SUT for measurement, the largest amplitude aberrations are reduced to predominantly second and fourth order. This reduces the amplitude of aberration required for the nulling component. In the case where there is a clear dominant aberration such as spherical aberration or astigmatism it can be decoupled from the nulling component and introduced in the focusing elements by amending the surface description to asphere or biconic surfaces.

The sub-aperture can be displaced along the radius of the SUT by manipulating the chief ray angle. Rotation of the SUT about the central mechanical axis, the z-axis, allows the SUT to be completely covered with overlapping sub-aperture footprints.

Retrace error often presents a challenge with the interferometric measurement of optical surfaces. This is addressed in the arrangements of the specification by ensuring that the chief ray is normal to the SUT for each sub-aperture. Modifying the chief ray angle is carried out using a tip-tilt mirror and another mechanical movement. A mechanically shifting and tilting relay mirror is incorporated for the measurement of convex surfaces, labelled as components 115, 3 and 120, 4 in FIGS. 1A and 1B, respectively.

The present specification relates to an improved system to provide central position for alignment and central sub-aperture measurements. The specification provides exemplary arrangements for improved optical surface manufacturing and measurement. Referring to the exemplary arrangement of FIGS. 1A and 1B, 3A and 3B and 4A and 4B, all components of the system are aligned along a central axis, or the z-axis as it is referred to in optical notation. The orientation of the optical system in FIGS. 1A and 1B is that the z-axis is aligned with the central axis of rotational spindle 126, which may comprise a vacuum chuck. The x-axis lies perpendicular to the z-axis along the plane and the y-axis points out of the illustration.

In these exemplary arrangements the central axis may comprise a central machining axis. The optical metrology system 100 may be used in co-operation with a system for machining or manufacture of optical surfaces. In such arrangements the optical surface also referred to as the surface under test is arranged mounted to a rotational spindle and the optical metrology system is optically coupled to the SUT, such that an optical beam of the system 100 is controllably positionable at a location on the surface of the SUT.

A system 100 according to an exemplary arrangement of the present specification is described with reference initially to FIGS. 1A and 1B, 2 and 3Aa and 3B. The system 100 is configured to provide a central position for alignment and central sub-aperture measurement is shown in FIGS. 1A and 1B.

The system 100 comprises an exit pupil 105, optical elements 110, first mirror 115, second mirror 120, a surface under test 125 and a beam to interferometer pupil 130. The optical elements 110 comprise partial nulling, or focusing, elements 110.

In the arrangement shown, the first mirror is a tip/tilt mirror or a beam steering mirror. The second mirror is a relay mirror. The first and/or second mirrors may be reconfigurable mirrors. A controller 200 is configured to control the positions of the mirrors and the SUT, as described below and shown in the drawings.

The tip-tilt mirror 115 and the relay mirror 120 may be configured for mechanically shifting and tilting for the measurement of convex surfaces.

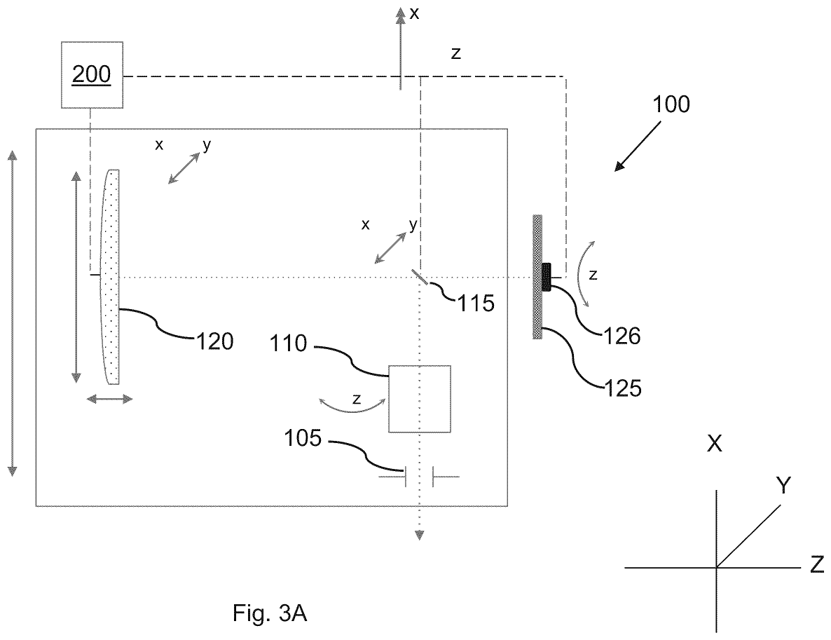

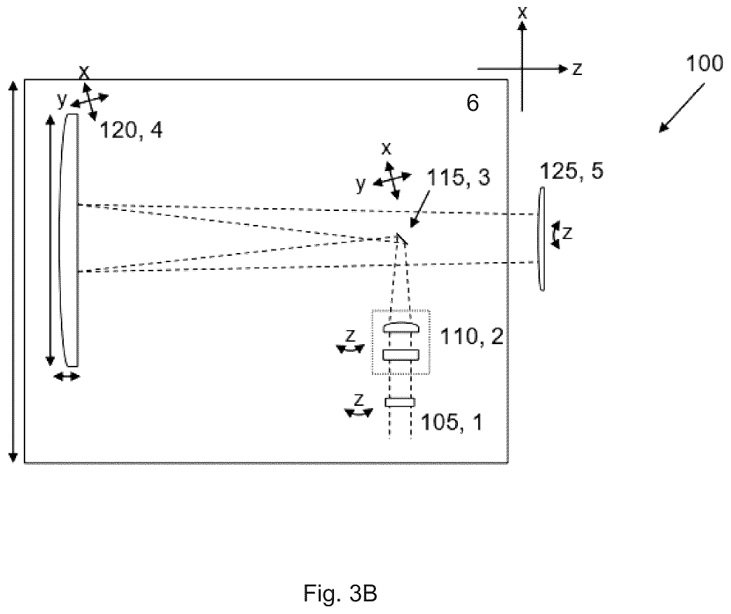

Each of the tip-tilt mirror, 115, and at least one relay mirror, 120, are mechanically configured to provide the following degrees of freedom to enable re-direction of the chief ray:
Tilt about the x and y axes for the tip-tilt mirror (component 3 in FIG. 3B).
Tilt of the relay mirror (component 4 in FIG. 3B) about x and y axes. Lateral displacement of the relay mirror (component 4 in FIG. 3B) along the x and y axes.
Lateral displacement of the full metrology system, labelled as 6 in FIG. 1B, along the x-axis only, with respect to the SUT (component 5 in FIG. 3B).
Longitudinal displacement of the relay mirror (component 4 in FIG. 3B) along the z-axis.
Rotate the SUT about the z-axis, which is the central mechanical axis.

Movements including one or more of the above mechanical movements support position of the SUT/SA and the optical metrology system including one or more of the mirrors 115, 120 as required for the re-direction of the chief ray.

In other arrangements, further additional adjustment or mechanical movements of the components and positioning and relative positioning there can be provided:
For non-rotationally-symmetric focusing elements, the elements shall rotate about the z-axis.
For a static nulling element, such as a phase plate, the element shall be rotated about the z-axis.

The elements may be a pair of cylindrical lenses.

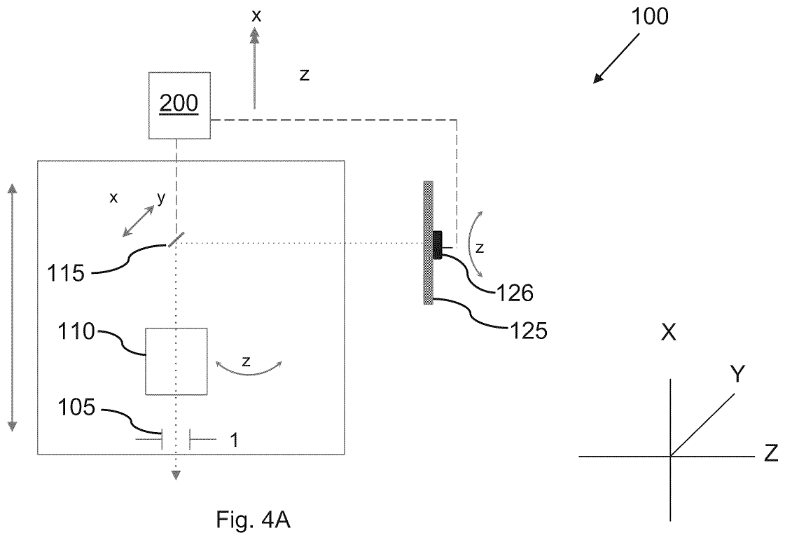

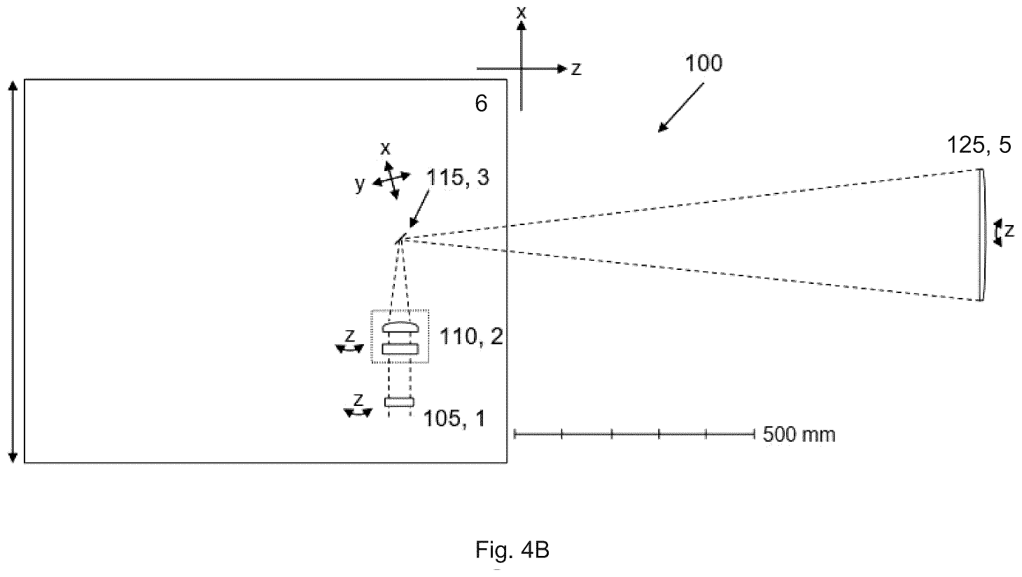

In one exemplary arrangement, provide for measurements of a concave freeform optical surface use of the relay mirror 120 may be omitted. The tip-tilt mirror 115 may be adjusted and positioned as required for example at the centre of curvature of the SUT as per the arrangement shown in FIG. 4A.

In one exemplary arrangement, mechanical movements for concave optic measurement may be as follows:
Tilt about the x and y axes for the tip-tilt mirror 115.
Lateral displacement of the full metrology system, labelled as 6 in FIG. 4B, along the x-axis only, with respect to the SUT 125 (component 4 in FIG. 1B.
Rotate the SUT 125 about the z-axis, which is the central mechanical axis. Custom mechanical movements for convex optic measurement may be as follows:
For non-rotationally-symmetric focusing elements, the elements shall rotate about the z-axis.
For a static nulling element, such as a phase plate, the element shall be rotated about the z-axis.

In each of FIGS. 1A and 1B, 2 and 4A and 4B, components of the system 100 are aligned along the central machining axis, or the z-axis as it is referred to in optical notation. The system comprises a central sub-aperture 105, an optic 115. The orientation of the optical system in FIG. 1A is that the z-axis is aligned with the central axis of chuck 126. Chuck 126 may comprise a vacuum chuck. The x-axis lies perpendicular to the z-axis along the plane and the y-axis points out of the illustration.

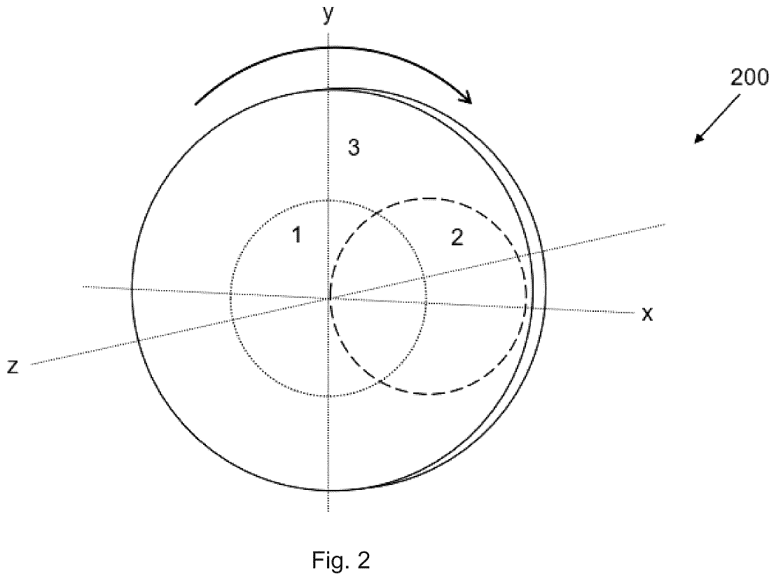

The optic 125 may be a freeform optic. An example for a freeform optic is shown in FIG. 2. This optical surface is mounted within the system as an SUT 125 on rotational spindle 126. The position of the rotational spindle 126 and the SUT mounted thereon is controllable by the controller 200.

The controller 200 comprises any suitable controller including a processor and memory and operable including to output control signals to the SUT mount 126 and to optical metrology system including first and second mirror, and other moveable or adjustable components thereof.

Referring to the example of FIG. 2, the optic/SUT 125, 3 is illustrated as having two superimposed sub-aperture footprints on the surface illustrating that the central sub-aperture labelled as 1 and 2. According to the specification the SUT 125 or optic 3 is mountable to a rotational spindle such that it can be radially shifted from a first position to a second position 2 using the degrees of freedom of the system. To successfully cover the SUT with sub-aperture footprints the SUT can be rotated about the central machining axis, which is the z-axis of rotation in FIG. 2 notation and is labelled as z-axis in FIG. 1A.

In the example provided in FIG. 1B, fourth order astigmatism is removed from the exit pupil and introduced into the system by means of two orthogonal cylindrical lenses, an aspherical lens if the dominant aberration is spherical aberration. The residual aberration is then introduced in the pupil plane, labelled as 1 in FIG. 1B.

FIG. 2 illustrates two sub-aperture footprints 1, 2 and an exemplary freeform SUT 3. Shown is the rotation of the optic surface about the central machining axis, z-axis. FIG. 3 illustrates the arrangement of FIG. 1A and further illustrates the degrees of freedom of the mechatronics for measurement of a freeform optical surface with a convex base shape. The mechanical movements are shown by arrows and axes.

Referring to FIGS. 3A and 3B, the degrees of freedom of movement supported by the system 100 to fulfil the chief ray criterion for a convex surface are shown in FIGS. 3A and 3B. The mechanical movements provided for the re-direction of the chief ray are:
Tilt about the x and y axes for the tip-tilt mirror (component 115, 3 in FIG. 3B).
Tilt of the relay mirror (component 120, 4 in FIG. 3B) about x and y axes.
Lateral displacement of the relay mirror (component 120, 4 in FIG. 3B) along the x and y axes.
Lateral displacement of the full metrology system, labelled as 6 in FIG. 1B, along the x-axis only, with respect to the SUT (component 125, 5 in FIG. 3B).
Longitudinal displacement of the relay mirror (component 120, 4 in FIG. 3B) along the z-axis.
Rotate the SUT about the z-axis, which is the central mechanical axis.

### Custom Mechanical Movements Required are:

For non-rotationally-symmetric focusing elements, the elements are configured rotate about the z-axis. The system is configured to support rotation of the optical elements about the z-axis. In an exemplary arrangement, the optical elements may comprise a pair of cylindrical lenses.
For a static nulling element, such as a phase plate, the element is configured to be rotated about the z-axis.

FIGS. 4A and 4B illustrate an optical system having an exit pupil 105, a mirror 115 and a surface under test 125. The system further comprises partial nulling, or focusing, elements 110. The mirror may be a tip/tilt mirror or a beam steering mirror. The mirror may be a reconfigurable mirror. A controller 200 is configured to control the positions of the mirror and the SUT, as described above.

FIGS. 4A and 4B further illustrate degrees of freedom of the mechatronics required for the measurement of a freeform optical surface with a base shape that departs from convex.

In an exemplary arrangement for a concave freeform optic measurement, the use of the relay mirror 120 may be omitted as in FIGS. 4A and 4B. The exemplary arrangement illustrated instead provides for a repositioning of the tip-tilt mirror 115, as shown in FIGS. 4A and 4B. The tip-tilt mirror 115 may be repositioned at the centre of curvature of the SUT. The mechanical movements required for concave optic measurement are:
Tilt about the x and y axes for the tip-tilt mirror (component 3, 115 in FIG. 4B).
Lateral displacement of the full metrology system, labelled as reference number 6 in FIG. 4, along the x-axis only, with respect to the SUT (component 120, 4 in FIG. 1B.
Rotate the SUT about the z-axis, which is the central mechanical axis.

### Custom Mechanical Movements:

For non-rotationally-symmetric focusing elements, the elements are configured to be rotated about the z-axis.
For a static nulling element, such as a phase plate, the element is configured to be rotated about the z-axis.

The metrology system is configured to provide for re-construction of large-aperture optical surfaces such as a freeform optical surface or an asphere. The system is configured to support measurements of optical properties of the optical surface, including one or more of: phase map data, wavefront measurements, and wavefront error measurements. The SA measurements may comprise fringes or phase data, and the fringes or phase data for each SA is at least partially nulled.

The extent to which the interferograms can be resolved is dependent on the pixel pitch of the interferometer. The sampling criterion states that the absolute value of the phase difference between any two consecutive phase samples (i.e. pixels) is less than π:

$$W ( x , y ) < \frac{λ}{2 ( Δ x )} ,$$

where Δx is the difference between two consecutive pixels [Nyquist].

In summary, the specification provides an optical metrology system 100 for measuring the wavefront error of large, non-standard optical surfaces.

In some embodiments, the system and methods of the specification further provide that interferograms from individual SAs are stitched together to reconstruct the full surface. Non-standard optics may have regions that are very steep, meaning that they are challenging to measure. The partial nulling method described herein, based on the configuration of the SUT and the metrology system support such measurements.

In an exemplary arrangement of the specification, advantageously the SUT is mounted on a rotational spindle, which is mechanically separate from the metrology system. The metrology system includes a reconfigurable relay mirror and a reconfigurable tip/tilt mirror, each having six degrees of freedom motion. These reconfigurable mirrors (relay and tip/tilt) are positioned such that the fringes from the particular SA under consideration are partially nulled. Thus, the manufacturing and measuring processes are completely decoupled, removing the metrology bias that exists in other systems, such as confocal ones.

Variable optical elements are used to further null the fringes at each SA position, maximising the available measurement range for that particular measurement. A digital twin of the full system is used to plan the SA lattice layout using a custom software routine, model the nulling required and achievable at each location, and simulate the machine output at that location. This lattice design process can be iterated upon to achieve the accuracy required. Planning using the digital twin is done prior to taking any actual data. Once the measurements have been taken, stitching of SAs is performed using software, to recreate the SUT over its full diameter. The software is optimised for speed to ensure that the computation time required to recreate a large diameter SUT from many SA measurements does not become impractical. The system is compact enough to be integrated into a single point diamond turning (SPDT) polishing machine, making inline measurements possible.

FIGS. 4A and 4B illustrate an optical system having an exit pupil 105, a mirror 115 and a surface under test 125. The system further comprises partial nulling, or focusing, elements 110. The mirror may be a tip/tilt mirror or a beam steering mirror. The mirror may be a reconfigurable mirror. A controller 200 is configured to control the positions of the mirror and the SUT, as described above.

FIGS. 4A and 4B further illustrate degrees of freedom of the mechatronics required for the measurement of a freeform optical surface with a base shape that departs from convex.

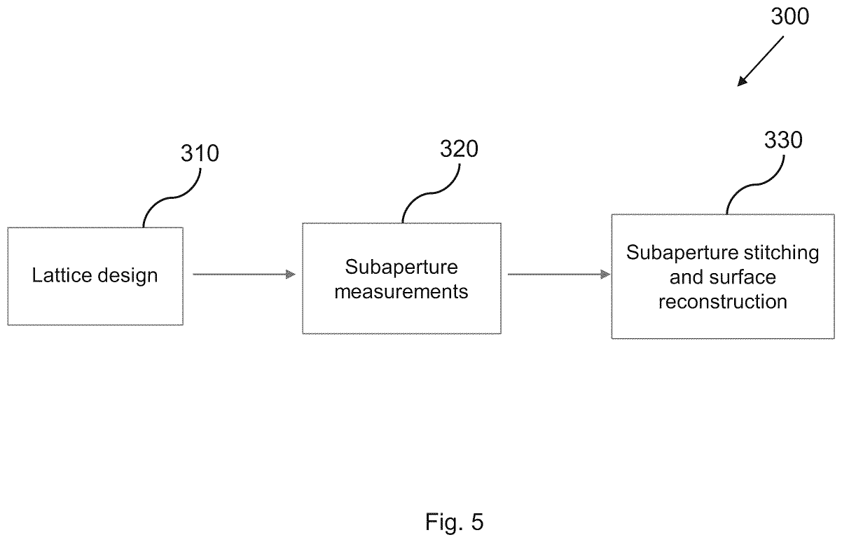

Modules 300 of, and related methods of operation of metrology system 100 are shown in FIG. 5. The methods comprise the following:
1. Lattice design.
2. Subaperture measurements.
3. Subaperture stitching and surface reconstruction.

Each of these three steps can be considered to be a module with dependent inputs and outputs for sequential execution. The aim is to have the reconstructed surface converge to the target SUT with repeated machining/polishing cycles. After these three steps, the reconstructed surface is compared to the target surface. If they match to within a desired tolerance, the machining/polishing process is deemed complete. If they do not, further polishing of the SUT is carried out to improve convergence.

The modules 300 may be provided integrated with or coupled to the controller 200. The modules may provide for processing of one or more of measurement data, system parameters and other inputs as noted above. The modules may be configured to provide

The module may be coupled to one or more processors and memory units comprising instructions executable to carry out the steps of the methods of the specification and to control the operation of the metrology system 100 and the components thereof.

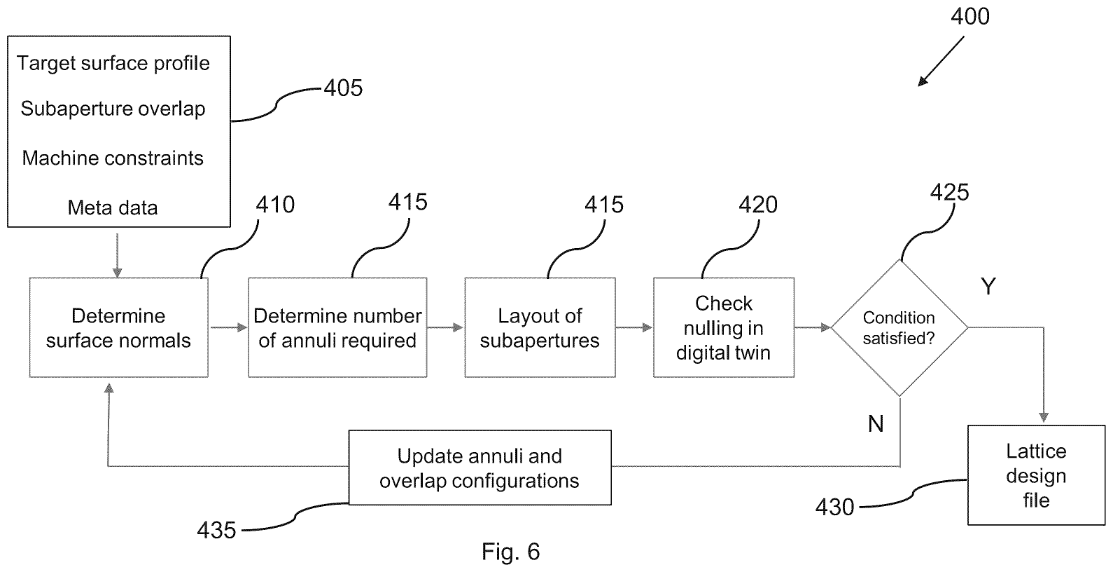

An exemplary custom lattice design routine is described with reference to FIG. 6. This routine is used to optimise the layout of the subapertures to fully cover any SUT, with sufficient percentage overlap between adjacent subapertures, SAs, to minimise errors, while reducing the time required to measure the full SUT.

Reference is made to FIG. 6.

Inputs 405 to the lattice design stage 310 include one or more of the following:
1. A high-resolution target surface or point cloud of the target surface. The high-resolution target surface or point cloud of the target surface may be received/exported from a ray tracing software application.
2. The desired or selected percentage overlap between adjacent subapertures. More overlap gives the stitching algorithm more information but takes longer to process the extra information. There is an optimum value to reduce noise to a desired level with the smallest amount of overlap possible.
3. A priori knowledge of hardware inaccuracies to ensure that results are within meaningful bounds.
4. Meta data such as SUT and subaperture sizes, camera resolution and pixel size. In a further exemplary arrangement of the specification there may be provided a system for creation of a digital twin 500 of the system 100. It will be appreciated that the digital twin may be used in combination with arrangements of the previously described embodiments.

In this exemplary arrangement integral to the lattice design step is the provision and creation of a digital twin of the system. The digital twin may be provided in a Zemax OpticStudio Application Programming Interface (API). The digital twin 500 allows for testing of the nulling capabilities (reference is made also to the exemplary arrangement of FIG. 6—steps 420, 425) of the metrology unit at each subaperture position prior to performing any physical measurements. In the digital twin 500, interferograms are simulated for the output of each subaperture. Image processing is used to analyse the resulting fringes, to determine whether or not the configuration is sufficient/meets requirements for nulling. If not, the lattice design algorithm goes through one or more further iterations where the lattice configuration parameters are adjusted. The process repeats until a satisfactory solution is found.

Outputs from the lattice design stage 310 include:
1. A lattice design file containing the position in 3D space of the centre of each subaperture. This data feeds into the stitching algorithm as it provides the initial configuration (position) of each subaperture in a global reference frame located at the SUT. It is also used to determine the measurement path of the machine.
2. The x and y tilts at these central coordinates.
3. The unit normal vectors at these central coordinates.

Once the optimum lattice design is fixed, the measurement trajectory of the metrology unit 100 (also referred to as the metrology system 100) is determined using a shortest path algorithm. The subaperture measurements 320 are acquired according to the measurement trajectory determined. Once a complete set of subapertures measurements has been gathered, the interferograms are fed to the stitching algorithm to reconstruct the full SUT surface profile. The departure/or not of the reconstructed surface from the target SUT at this stage is used to determine if further machining/polishing cycles are required.

The stitching algorithm consists of finding a configuration for each subaperture that minimises the differences between subapertures in the regions of overlap. Subapertures are stitched simultaneously and the constraints on allowed configurations are determined by the allowed motion and tolerances of the machine.

A lattice configuration (311) consists of a set of affine transforms for each subaperture (three translation matrices and three rotation matrices) that positions that subaperture in 3D space whilst minimising the differences in the overlap regions in a least-squares sense. With excellent machine tolerances and precision positioning ability, the best configuration for each subaperture should ideally be only a small perturbation to the designed configuration as determined at the lattice design stage.

Reference is made to FIG. 6 which provides inputs 405 including target surface profile, subaperture overlap, machine constraints and meta data. At 410 surface normal are determined. At 415 the number of annuli required are determined. At 415 a layout of subapertures is provided. At 420 a check of nulling in the digital twin is provided. At 425 a determination is made to whether the condition is satisfied. In an exemplary arrangement Image processing is used to analyse the resulting fringes, to determine whether or not the configuration is sufficient/meets requirements for nulling. If not, the lattice design algorithm goes through one or more further iterations where the lattice configuration parameters are adjusted at step 435. The process repeats until a satisfactory solution is found. When the condition is positively satisfied at 235—then at 430 the lattice design file is generated.

The ideal configuration (311) is arrived at using an iterative process. In the present implementation of this stitching algorithm, the loop runs typically <10 times and the solution affine matrices are stored at each iteration. The ‘best’ affine is chosen at the end of the process and applied to the subaperture measurement points. The corrected subaperture data points are then stitched, taking into account the number of overlaps at each pixel, to reconstruct the final surface. To ease the iterative stitching process smoothly towards a good solution with minimal overshoots, a loop gain is applied when updating the affine matrices between iterations.

The arrangements of the specification further address issues relating to processing load that may arise in the event that the camera used to acquire subaperture measurements has high resolution, and that further may arise at processing including stitching. Stitching algorithm may result in space and time bottlenecks associated with managing and processing very large data sets. (A camera with 1000×1000 pixels results in 1E6 data points per subaperture.)

To provide a solution that addresses these problems the following are provided.
1. Use of software for example open source packages that are optimised for manipulation of large arrays; the Python NumPy package.
2. The custom stitching code of the arrangement of the specification includes the option to process a reduced (randomly selected) number of pixels in the full-resolution phase maps. To optimise operation the system is configured to provide for coarser sampling while maintaining a good resolution. The level of sampling (fine/coarse) can be tailored to the particular SUT. After the optimum configuration for each subaperture has been found by least squares minimisation of the differences between sub apertures in the overlap regions, the full resolution maps are used to build the composite surface. Variable sampling may be used to reduce computation time. Further advantageously it does not result in a lower resolution stitched surface than that expected from the camera properties.
3. The arrangements of the specification advantageously reduce computation time by making use of parallel processing techniques so that some stitching tasks which can be completed in any sequence are run in parallel rather than sequentially. The order in which tasks are run is flexible.

Aspects of the arrangements of the specification and related advantages are set out in the following clauses.

According to a first aspect there is provided a metrology unit capable of reconstructing large-aperture freeform optical surface shapes from many overlapping, partially-nulled subaperture phase maps. Partial nulling is achieved through a novel configuration of the SUT and the metrology machine itself. The SUT is mounted on a rotational spindle, which is mechanically separate from the metrology system we describe. The metrology system includes a reconfigurable relay mirror and a reconfigurable tip/tilt mirror, each having six degrees of freedom motion. These reconfigurable mirrors (relay and tip/tilt) are positioned such that the fringes from the particular SA under consideration are partially nulled. Thus, the manufacturing and measuring processes are completely decoupled, removing any metrology bias.

An embodiment is configured to perform all subaperture measurements inline between machining steps, removing the need to take the SUT out of the rotational spindle (chuck) in order to perform measurements. This allows for decoupling of the metrology bias that may exist in other inline metrology systems, such as confocal ones.

In one embodiment a custom lattice design routine is used to optimise the layout of the subapertures to fully cover any SUT while minimising the required measurement time. This is achieved by reducing the number of subapertures required to cover the SUT and by efficiently arranging the subaperture overlay pattern.

The lattice design routine uses the following inputs to create the optimised lattice design which will feed to the measurement trajectory and the stitching algorithm:
a high-resolution target surface or point cloud of the target surface exported from commercial optical design packages
metrology unit constraints, which are very much machine dependent, but will be fixed and known for any particular machine.
metadata relating to the desired resolution, surface dimension properties, and maximum subaperture dimensions.

In one embodiment, the metric for a successful lattice design is that it meets the required fringe resolution criteria for every subaperture.

In one embodiment, if the resolution criteria are not fulfilled, the lattice configuration (311) requirements (inter-annulus and adjacent overlap percentages) are updated. The design then iteratively repeats the previous steps until a suitable solution is achieved.

The lattice configuration may be configured for input to commercial ray-tracing software via an Application Programming Interface (API) to create a digital twin of the physical measurement system. Using this digital twin, all interferograms are simulated for the output of each subaperture. Fringe resolution analysis via image processing is used to determine if the configuration is sufficient for nulling.

The ability to perform measurements inline drives the compact and reconfigurable design of the invention so that it can be integrated into an industrial machining or polishing environment.

The ability to perform measurements inline without touching the SUT as it sits in the chuck means that the method is completely contactless.

In one embodiment machine mechanical bias is removed from the data collection process by using a tip/tilt mirror and relay mirror in partnership to shift the sub aperture measurement position on the SUT, which is mounted on a rotational spindle.

In one embodiment partial nulling of individual sub apertures is achieved through a combination of static and variable optical elements and mechanical stages having six degrees of freedom motion.

In one embodiment partial nulling is achieved using two cylindrical lenses operating as a pair.

In one embodiment partial nulling may be additionally achieved with a static phase plate that can rotate about the optical axis.

In one embodiment a single surface shape may be provided by using a single static custom phase plate to achieve partial nulling.

In one embodiment, the arrangement allows for partial nulling to be achieved with a reconfigurable spatial light modulator (SLM), used in double pass, and placed in a plane conjugate to the SUT.

The arrangements may be configured to be extended to production of one-off surfaces by using a reconfigurable SLM to achieve partial nulling.

In one embodiment the system is configured to allow measurement of freeform optical surfaces with convex base shape.

An embodiment involves configuration of the system to allow measurement of freeform optical surfaces with concave base shape.

In one embodiment use of the metrology unit is extended beyond measurement of freeform optics to measurement of any challenging (steep surface) asphere.

Advantageously the arrangements are robust to obscurations in any subaperture that may be created by an optical element in the beam path. This robustness is built in at the lattice design stage and in the implementation of the stitching algorithm.

Advantageously the lattice design routine is used to find the orientation of the metrology unit with respect to the SUT to null tip and tilt for each subaperture. As a first pass, the best fit base sphere is used, but if the nulling criteria are not met, the target surface/point cloud is updated to the original surface design. This step results in the generation of surface normal vectors at every grid point on the target SUT. In particular, the surface normal at the centre of each SA is identified for positioning of the machine so that measurements are made at normal incidence to the SUT. In a further embodiment, a high-order order polynomial can be used if the best fit base sphere is found not suitable

In one embodiment, a custom lattice design can be created for any SUT given the target surface, machine parameters, subaperture overlap requirements and other meta-data.

In one embodiment the freedom of individual optical elements or groups of optical elements, suitably mounted in precision stages, to move with six degrees of freedom allows each subaperture to be measured at normal incidence.

An embodiment of the design allows for variable sampling of subaperture measurements in the stitching algorithm. For very high-resolution measurements, the time taken to stitch many subapertures may become impractical. Variable sampling allows the algorithm to run faster and find a quick solution. There is no loss in resolution in the measurements themselves. The sampling can be tailored to the desired accuracy required for the reconstructed surface.

The stitching algorithm may be optimised through use of parallel processing techniques to reduce data processing time.

Rather than auto detection of overlapping subapertures, which involves a lot of checking, a list of overlapping subaperture pairs is provided to the stitching algorithm. This reduces complexity as the list does not change from run to run.

To allow for smooth convergence of the stitching algorithm, a loop gain is introduced when calculating the new configuration at each iteration of the loop. This has the effect of reducing the number of iterations required to achieve convergence as there is no overshooting.

What is claimed is:

1. A partially nulling optical metrology system for measurement of large aperture and freeform optical surfaces, the metrology system comprising:
a first mirror having a plurality of degrees of freedom of motion;
one or more optical elements comprising reconfigurable optical elements; and
a controller;
the metrology system configured to be optically coupled to an externally located surface under test (SUT) and to capture measurement data from each of a plurality of individual subapertures (SAs) across an area of the SUT, each SA having a surface area smaller than that of the SUT; and
the metrology system configured to provide partial nulling of each of the SA measurements across the SUT, based on controlled adjustment of one or more of: the metrology system and the optical elements thereof;
wherein a position of the metrology system relative to the SUT is adjustable, the metrology system being coupled to a moveable mount and the controller operable to adjust the position of the metrology system;
wherein the reconfigurable optical elements are adjustable relative to the SUT;
wherein the first mirror is adjustable relative to the SUT; and
wherein the measurement data, comprising measurements relating to the plurality of individual SAs is stitched to describe a full surface of the SUT.

2. The system of claim 1, wherein the first mirror comprises a beam steering mirror, wherein the beam steering mirror is reconfigurable, having six degrees of freedom of motion.

3. The system of claim 1, further comprising a second mirror, the second mirror comprising a relay mirror wherein the relay mirror is reconfigurable, having six degrees of freedom of motion.

4. The system of claim 1, wherein the first and second mirrors being adjustable relative to the SUT, and the plurality of SAs, across the SUT; and
wherein the position of the first and second mirrors is controllable to provide a partial nulling of the individual SA measurements across the SUT.

5. The system of claim 1, wherein the position of the metrology system is adjustable to allow positioning of the metrology system such that measurements are made substantially normal to the SUT, and the plurality of SAs, across the SUT.

6. The system of claim 1, configured to measure wavefront errors of the optical surface of the SUT, by measuring wavefront errors from each of a plurality of individual overlapping SAs of the SUT, each SA having a surface area smaller than that of the SUT, and wherein a reconstruction of the optical surface, is provided by the plurality of partially nulled overlapping subaperture measurements.

7. The system of claim 1, wherein the controller is configured to control the position of one or more of the: metrology system, the first mirror, and the second mirror, to position an optical beam on the SUT, as required.

8. The system of claim 1, wherein a position of the SUT is adjustable, the SUT being coupled to a moveable mount, and configured for movement independently of the metrology system such that any mechanical bias of the system is removed from a data collection process.

9. The system of claim 1, wherein the controller is configured to control the position of the SUT, to allow selection of one or more individual SAs, such that an optical beam is positioned on an SA of the SUT.

10. The system of claim 1, wherein the SUT is mountable to a rotational spindle and wherein the controller is configured to control the position of the SUT, to allow selection of one or more individual SAs, such that an optical beam is positioned on an SA of the SUT.

11. The system of claim 1, further comprising an interferometer, wherein the measurement data from each of the SAs comprises phase maps or interference fringe data.

12. The system of claim 1, wherein the metrology system is configured to be integrated into an industrial machining or polishing environment.

13. The system of claim 12, wherein the metrology system is configured to capture measurement data according to one or more of the following:
(i) wherein measurement data comprising subaperture measurements of the SUT is captured in an inline process; and
(ii) wherein measurement data comprising subaperture measurements of the SUT is captured between machining steps during the process of manufacture of the SUT.

14. The system of claim 1, further comprising a lattice design module
wherein the lattice design module is configured to create an optimised lattice configuration wherein the lattice configuration comprises one or more of a definition of a measurement trajectory for a SUT, and a stitching algorithm for stitching of SAs of an SUT.

15. The system of claim 14, wherein the lattice design module is configured to use one or more the following inputs:
(a) a high-resolution target surface or point cloud of the target surface, and further wherein the target surface may be obtained from an optical design software;
(b) metrology unit constraints, comprising data that is fixed and known for any particular machine; and
(c) metadata relating to desired outputs including desired resolution, surface dimension properties, and maximum subaperture dimensions.

16. The system of claim 14, wherein a predefined minimum threshold requirement for creation of a lattice design is defined based on a required fringe resolution criteria threshold for every SA and wherein in the event that the required fringe resolution criteria threshold is not met, the lattice configuration requirements are updated, and wherein the lattice configuration requirements may comprise one or more of (i) inter-annulus and (ii) adjacent overlap percentages.

17. The system of claim 1, wherein the optical elements are configured to provide partial nulling of individual sub apertures, the optical elements comprising at least two cylindrical lenses, wherein the at least two cylindrical lenses are configured to be adjustable and for use in conjunction with one another, and configurable to provide partial nulling of individual subapertures.

18. The system of claim 1, wherein the optical elements are configured to provide partial nulling of individual sub apertures, the optical elements comprising a static phase plate, wherein the static phase plate is configured to rotate about an optical axis to provide partial nulling of individual subapertures.

19. A method for capturing measurement data of the optical surface of a surface under test (SUT) in a partially nulling metrology system as claimed in claim 1, the method comprising:
optically coupling the metrology system to a SUT, wherein the SUT is located externally of the metrology system;
capturing measurement data from each of a plurality individual subapertures (SAs) across the area of the SUT, each SA having a surface area smaller than that of the SUT;
stitching of the measurement data comprising measurements relating to the plurality of individual SAs to describe the full surface of the SUT; and
controlling the metrology system and the elements thereof to provide partial nulling of each of the SA measurements across the SUT, wherein said partial nulling is provided based on one or more of the following:
adjusting the metrology system relative to SUT, wherein the metrology system is mounted to a movable mount for positioning relative to the SUT;
adjustment of one or more optical elements of the metrology system relative to the SUT; and
adjustment of the one or more mirrors of the metrology system relative to the SUT;
the method further comprising:
adjusting a position of the SUT relative to metrology system as required, the SUT being mountable to a movable mount.

20. The method of claim 19, wherein the method further comprises:
controlling the optical metrology system and a measurement trajectory for the SUT based on operating a lattice design module to create an optimised lattice configuration and to define the measurement trajectory and stitching algorithm for stitching of the SAs in an iterative process.
